(19) United States
(12) Patent Application Publication
(10) Pub. No.: US 2005/0062696 A1
(43) Pub. Date: Mar. 24, 2005

(54) Driving apparatus and method of a display device for automatically adjusting the optimum brightness under limited power consumption

(76) Inventor: Shin-Tai Lo, Miaoli City (TW)

Correspondence Address: BIRCH STEWART KOLASCH & BIRCH, PO BOX 747, FALLS CHURCH, VA, 22040-0747, US

(21) Appl. No.: 10/669,016

(22) Filed: Sep. 24, 2003

(51) Int. Cl. G09G 3/32

(52) U.S. Cl. 345/82

(57) ABSTRACT

A driving apparatus of a display device for automatically adjusting the optimum brightness under limited power consumption aims to obtain different ratio of the brightness to the image data value under different image loading. When the picture image loading is greater, the driving device of the invention automatically decreases the ratio of the brightness to the image data value to ensure the power consumption of the display panel being lower than the specification value. When picture image loading is smaller, the driving device of the invention automatically increases the ratio of the brightness to the image data value to increase the display brightness of the panel image and enahnce the contrast ratio.

### FIELD OF THE INVENTION

The present invention relates to a driving apparatus of a display device for automatically adjusting the optimum brightness under limited power consumption mainly and automatically adjusts the optimum display brightness under limited power consumption based on different picture image loading conditions and improves the image brightness to enhance the contrast ratio.

### BACKGROUND OF THE INVENTION

Organic light-emitting diode (OLED), also called organic electroluminescence (OEL), is a new generation technology and is unmatchable by other flat display device technologies. It provides a brighter and clearer full-color image and has a faster response speed.

The basic structure of OLED includes an anode made from a thin and transparent Indium Tin Oxide (ITO) which has the properties of semiconductor and a metal cathode to sandwich an organic material layer therebetween. The organic material layer includes an electric hole transmission layer (HTL), an emitting layer (EL) and an electron transmission layer (ETL). When a battery provides a suitable voltage (with characteristics of low voltage), electric charges injected into the electric hole of the anode and electric charges from the cathode couple in the emitting layer to generate electroluminescence on the organic material layer. The structure of the organic layer and design selection of the anode and cathode are the critical factors for the OLED device to fully deliver its light emission effect.

OLED has many features, such as it can emit light by itself It does not need a back light module. It can be driven by a low voltage (less than 10 Volts) and save electric power, has a high energy efficiency (16 lm/W), greater brightness (can reach 100,000 cd/m² or above), fast response time (less than 2 μs), high contrast ratio, wide viewing angle (proximate to 180°), light weight, small thickness, sample construction, lower fabrication cost, flexible (plastics base) and full-color enabling.

Hence OLED has been widely used. It has a great market potential in the display devices or illuminating equipment, such as mobile phones, game players, audio system panels, digital cameras, personal digital assistants (PDAs), car navigation systems, electronic books, information home appliances, notebook computers, monitors, TVs, etc.

When the OLED is used as an element in portable or handheld electronic products such as mobile phones, PDAs, digital still cameras (DSC), digital video cameras (DVC), there is a fundamental and important requirement on its property, i.e. low power consumption. Hence producers generally request that these elements must be operated within a limited power consumption range. As far as the mobile display device is concerned, the power consumption of an OLED panel must be lower than the specification value whenever it displays any image picture.

As the OLED is a self-lighting display device, it is expected that the OLED panel consumes greatest electric power when it displays all white images. This is because the image loading is the maximum value at that occasion (the amount of image loading is the sum of the image data value of every pixel of the display panel). Namely, image data value of every pixel is maximum (if the image data is 8-bit, the maximum value is 255). Hence in order to make the power consumption limited below the specification value, conventional methods are to adjust the brightness when the display image data value of every pixel is at maximum value so that when the OLED panel displays the all-white image picture the electric power consumption of the panel is exactly equal to the limited power consumption value. Referring to FIG. 1 for the relationship between the brightness and image data of each pixel of a conventional technique. When the electric power consumption of the OLED panel for displaying all-white image picture is adjusted to be equal to the limited power consumption value, the light intensity emitted by each pixel is defined as the brightness Lmax of each pixel when the image data value is at maximum value. When the pixel displays other image data value, such as n, its brightness is equal to Ln, where Ln=n×(Lmax/255).

Moreover, image contrast ratio (CR) is basically defined as the ratio of the maximum brightness value of the image display to the minimum brightness of the image display. The equation is CR=Lmax/Lmin. Thus while the conventional methods mentioned above enable the OLED panel to keep the consumed power below the specification value during displaying any image picture, the contrast ratio of the displaying image is restricted.

U.S. Pat. No. 6,380,943 entitled: “Color display apparatus” discloses an image data process technique applying to self-lighting flat panel display devices such as OLED, PDP and the like. Its objective is to increase the display brightness within the limited power consumption by automatic modulating based on different image loading conditions, and in the mean time to satisfy the requirements of power consumption and image quality.

That patent employs a principle as follows: first, divide the image loading into five areas according to light and heavy degree; the five areas use different parameters and curves to adjust the original image data value, with the image data of different image loading adjusted by different parameters and curves, then are displayed on the panel. Thereby when any image picture is displayed, the consumed power is lower than the specification value. And optimum brightness can be adjusted and displayed based on different image loading conditions. It meets the requirements of power consumption and image quality.

However it also has disadvantages, such as it requires a great number of digital image processing units and complex mathematical processes. Although it can achieve an improved image quality, it has to pay an expensive cost. It does not meet the low cost requirement of the small size AMOLED.

Japan Patent 2002-251167 entitled “Display device” discloses a current control circuit apparatus. It detects electric current flowing from a power source to the power source line of the AMOLED panel. When the detected electric current increases and is greater than the rated value, output voltage of the power source is reduced to lower the voltage on the power source line of the AMLOED panel to ensure that the AMOLED panel operates within the limited power consumption.

### SUMMARY OF THE INVENTION

Therefore the primary objective of the present invention is to solve the aforementioned problems and eliminate the drawbacks of cited prior art. The present invention aims at automatically adjusting the optimum display brightness under limited power consumption based on different image loading conditions and improving image brightness to enhance the contrast ratio, and in the mean time meeting the requirements of power consumption and image quality.

According to the invention, every pixel of the display device has an OLED element which is connected with each other in a co-cathode fashion. The co-cathode is connected to a resistor which has other end grounded. In addition, the anode of the OLED element of each pixel is connected to a power supply line (Vdd supply line) through a driver unit. Thereby when the image loading of the picture is greater, it is expected that in each pixel of the panel the sum of electric current flowing through the OLED will be greater, i.e. total current (Iₜₒₜₐₗ) flowing out of the co-cathode will be greater. However, due to a greater voltage drop occurs when a greater current flowing through the resistor, all driver units on the panel will have a smaller Vsd (voltage on the source electrode and drain electrode) during operation. The ratio value of each gray scale brightness relative to the image data value will automatically decrease, therefore power consumption of the panel will be lower than the specification value.

When the picture image loading is smaller, it is expected that in each pixel of the panel the sum of electric current flowing through the OLED will be smaller, i.e. total current (Iₜₒₜₐₗ) flowing out of the co-cathode will be smaller. However, due to a smaller voltage drop occurs when a smaller current flowing through the resistor, all driver units on the panel will have a greater Vsd during operation. The ratio value of each gray scale brightness relative to the image data value will automatically increase, therefore the brightness of the displaying image on the panel will be increased to enhance the contrast ratio.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a chart showing the relationship between the brightness (X-axis) emitted by each pixel and image data (Y-axis) of a conventional technique.

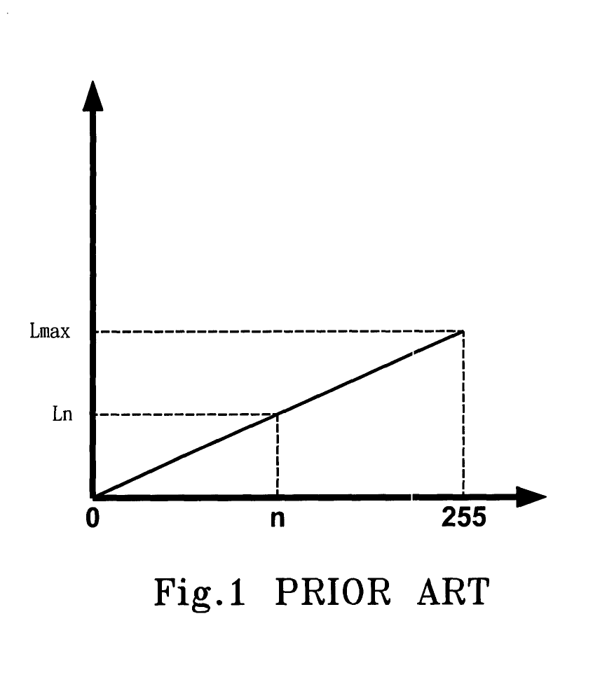

FIG. 2 is a chart showing the relationship between the brightness (X-axis) emitted by each pixel and image data (Y-axis) according to the invention.

FIG. 3 is a schematic diagram of the apparatus of the invention.

FIG. 4 is a chart showing the relationship between the maximum current (X-axis) and image loading (Y-axis) of an OLED panel according to the invention.

FIG. 5 is a chart showing the relationship betwen the voltage drop (X-axis) across a resistor and image loading (Y-axis) according to the invention.

FIG. 6 is a chart showing the relationship between the power consumption (X-axis) and the image loading (Y-axis) according to the invention.

### DETAILED DESCRIPTION OF THE PREFERRED EMBODIMENT

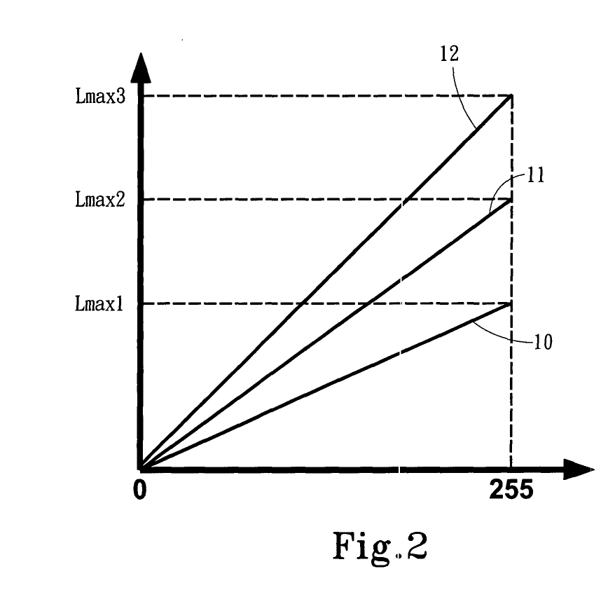

Please refer to FIG. 2 for the relationship between the brightness emitted by the pixel and the image data which inputted into the pixel according to the invention. The principle of the invention is that the ratio of the brightness to the image data value changed according to the image loading. When the picture image loading is greater (the transfer curve 10 for greater image loading shown in the FIG. 2), the driving device of the invention will automatically decrease the ratio of the brightness to the image data value to ensure the power consumption of the display device being lower than the specification value. When the picture image loading is smaller (the transfer curve 12 for smaller image loading shown in FIG. 2), the driving device of the invention will automatically increase the ratio of the brightness to the image data value to increase the maximum brightness of the display panel, therefore, the contrast ratio of the display panel is enhanced.

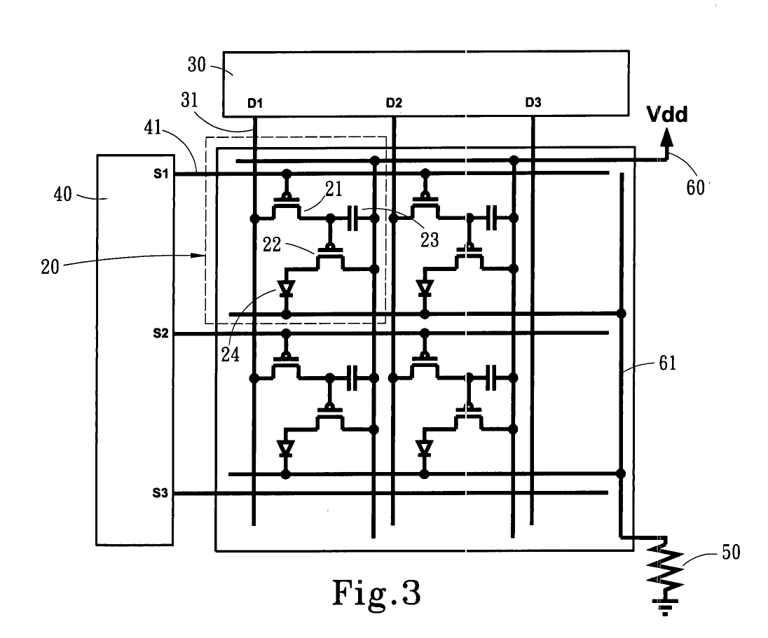

Please refer to FIG. 3, the apparatus of the invention includes a data driver 30 and a scan driver 40. The drivers set forth above drive the electronic elements in the circuits of every pixel 20 in the display device. The electronic elements include at least a switch unit 21 which has two input ends connecting respectively to a data line 31 and a scan line 41 and an output end, a storage unit 23 which has one end connecting to a power supply line 60 (for providing voltage Vdd) and another end connecting to the output end of the switch unit 21, a driver unit 22 which has one input end connecting to the juncture of the output end of the switch unit 21 and the input end of the storage unit 23 and another input end connecting to the power supply line 60, and an OLED 24. The OLED element 24 of each pixel 20 is connected to each other through a co-cathode connection line 61 in a co-cathode fashion. The co-cathode connection line 61 connects to a resistor 50 which has another end grounded. The anode of the OLED element 24 of each pixel is connected to the power supply line 60 (for providing voltage Vdd) through the driver unit 22.

The invention operates as follows: when the picture image loading is greater, it is expected that the sum of electric current flowing through the OLED 24 of each pixel 20 of the panel will be greater, i.e. total current (Iₜₒₜₐₗ) flowing out of the co-cathode connection line 61 will be greater. However, due to a greater voltage drop occurs when a greater current flowing through the resistor 50, all driver units 22 on the panel will have a smaller Vsd (voltage between the source electrode and drain electrode) during operation. The ratio of the brightness to the image data value will automatically be dressed; therefore the power consumption of the panel will be limited below the specification value.

When the picture image loading is smaller, it is expected that the sum of electric current flowing through the OLED 24 of each pixel 20 of the panel will be smaller, i.e. total current (Iₜₒₜₐₗ) flowing out of the co-cathode connection line 61 will be smaller. However, due to a smaller voltage drop occurs when a smaller current flowing through the resistor 50, all driver units 22 on the panel will have a greater Vsd (voltage between the source electrode and drain electrode) during operation. The ratio of the brightness to the image data value will automatically be increased, therefore the brightness of the displaying image on the panel will be increased to enhance the contrast ratio.

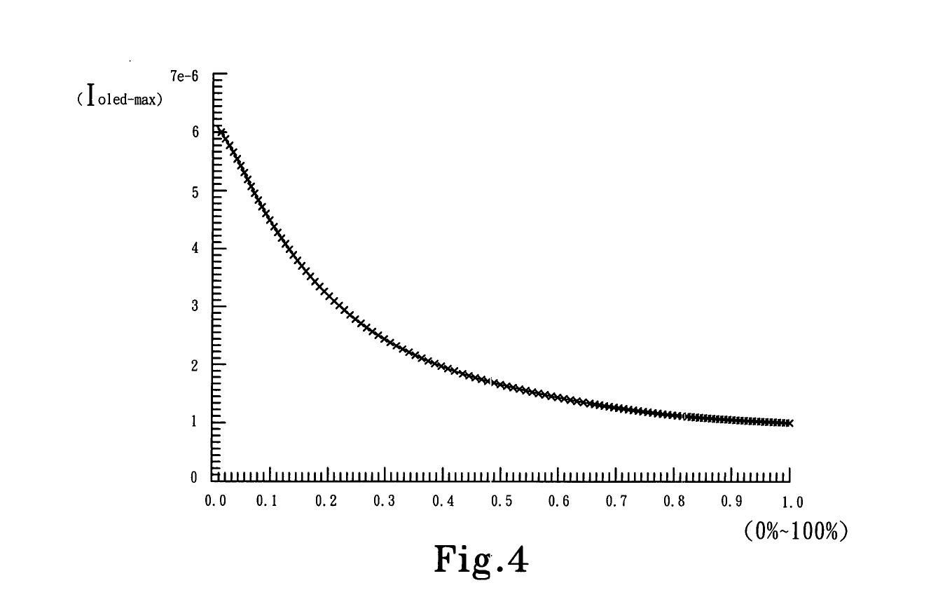

Please refer to FIG. 4 for the relationship between the maximum current of the OLED and the image loading according to the invention. As the driving device of the invention can automatically adjust the ratio of the brightness to the image data value in different image loading conditions, the brightness of the maximum gray scale in the different image loading conditions is different. In FIG. 4, the Y-axis represents the maximum current (I_{oled-max}) (i.e. corresponding to the maximum gray scale of image data) of the OLED, X-axis represents the image loading (0%-100%). When the picture image loading is greater, the maximum current (I_{oled-max}) of the OLED will automatically decrease, namely, the maximum gray scale brightness of the OLED 24 will automatically decrease to ensure the power consumption of the display panel being lower than the specification value. When the picture image loading is smaller, the maximum current (I_{oled-max}) of the OLED 24 will automatically increase, namely, the maximum gray scale brightness of the OLED 24 will automatically increase to increase the display brightness of the panel image to enhance the contrast ratio.

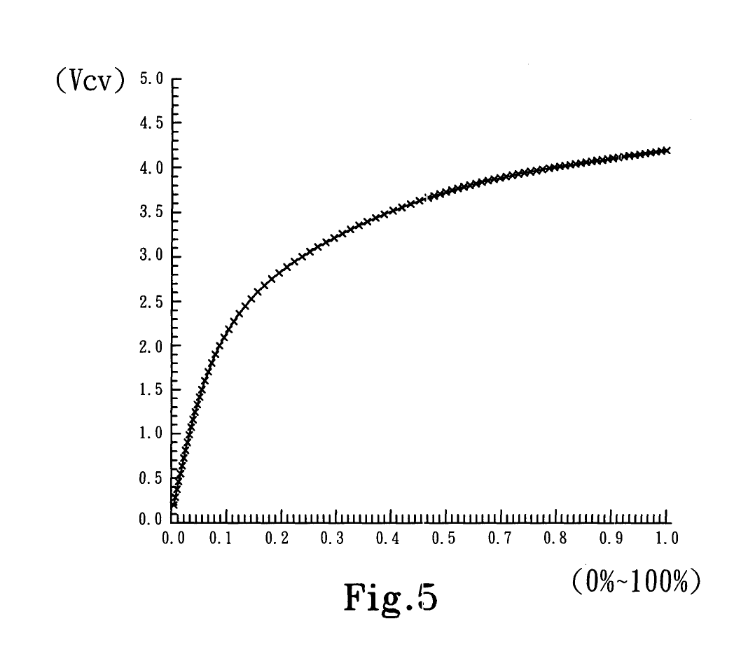

Please refer to FIG. 5 for the relationship between the voltage across the resistor 50 of the driving device and the image loading according to the invention. As shown in the drawing, under different image loading, total current (Iₜₒₜₐₗ) flowing out of the co-cathode connection line 61 will generate different voltage drop during passing through the resistor 50, thus the operating point of each gray scale of the driver unit 22 of the panel in different image loading will be different. The voltage drop (V_{cv}) across the resistor 50 varies continuously according to image loading condition. Thus the invention can generate continuous adjustment without producing blinking image, which may be caused by discontinuous adjustment.

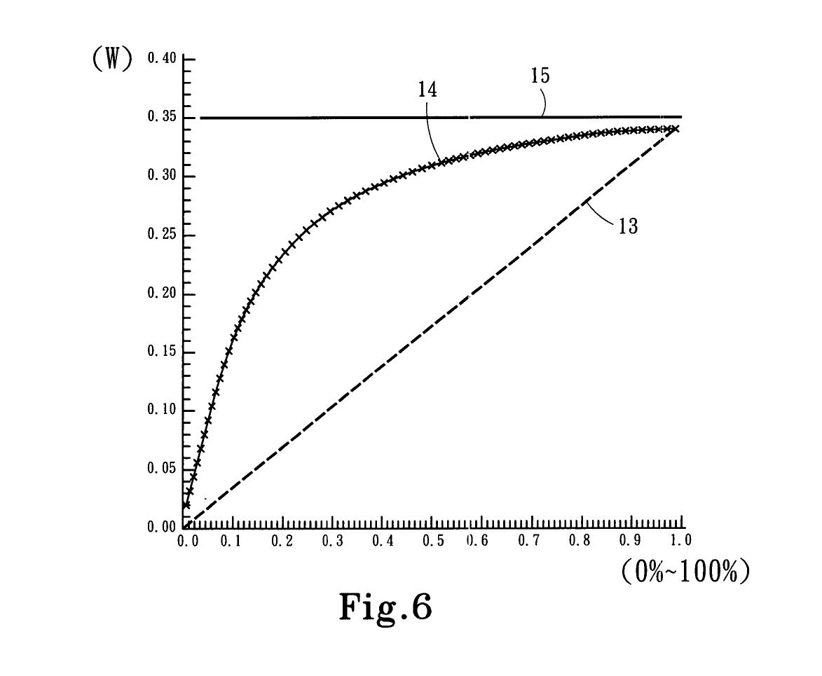

Please refer to FIG. 6 for the relationship between the power consumption of display panel and the image loading according to the invention. As shown in the drawing, in different image loading the OLED display panel has different power consumption. In the conventional methods, in order to make the power consumption lower than the power specification value 15, the OLED display panel is designed in such a manner that when it displays the all-white image picture, the electric power consumption is exactly equal to the limited value of the power specification value 15. Hence power consumption of the display panel of the OLED 24 is absolutely proportional to the image loading (as shown by the power consumption curve 13 in FIG. 6).

In contrast, the driving device of the invention can automatically adjust the ratio of the brightness to the image data value in different image loading condition. When the picture image loading is smaller, the maximum gray scale brightness will automatically be increased to increase the display brightness of the panel and enhance the image contrast ratio. Thus power consumption of the OLED 24 display panel is not directly proportional to the image loading (as shown by the power consumption curve 14 of the invention in FIG. 6). Therefore the power consumption of the display panel can meet the requirement of the power consumption limited value.

In summary, the invention provides the following advantages:
1. Enhance image contrast ratio. The invention, within the power consumption limitation and according to different picture image loading, can make automatic adjustment to achieve optimum brightness and increase the image brightness to enhance the contrast ratio, and in the mean time satisfy the requirements of power consumption limitation and image quality.
2. Continuous automatic adjustment. The technique provided by the invention can automatically adjust the ratio value of the brightness of each gray scale relative to the image data value under different image loading. The adjustment is accomplished by such an approach: under different image loading, total current (Iₜₒₜₐₗ) flowing out of the co-cathode through the resistor 50 generates different voltage drop, thus the operating point of each gray scale of the driver unit 22 of the panel in different image loading will be different. The voltage drop across the resistor 50 varies continuously according to image loading condition. In contrast, the conventional technique such as U.S. Pat. No. 6,380,943 (Apr. 30, 2002) has to use a built-in look-up table and complex mathematical process, and the adjustment incurs discontinuous alterations which results in some image blinking (caused by the picture being fallen into a middle blurred area of the relative image data ratios of two different gray scale brightness).
3. Lower cost. The panel according to the invention requires only an extra passive resistor. While the conventional technique such as U.S. Pat. No. 6,380,943 (Apr. 30, 2002) has to use a greater number of digital image processing units and complex mathematical processing that result in a higher cost and is not cost-effective for small size AMOLED that demands a lower cost.

While the preferred embodiment of the invention has been set forth for the purpose of disclosure, modifications of the disclosed embodiment of the invention as well as other embodiments thereof may occur to those skilled in the art. Accordingly, the appended claims are tended to cover all embodiments which do not depart from the spirit and scope of the invention.

1. A display device driving apparatus for automatically adjusting the optimum brightness under limited power consumption, comprising:
a data driver and a scan driver, wherein each pixel comprising:
a switch unit which has two input ends and an output end, the input ends connecting respectively to a data line and a scan line; and
a storage unit which has one end connecting to a power supply line and another end connecting to the output end of the switch unit;
a driver unit which has one input end connecting to the juncture of the output end of the switch unit and an input end of the storage unit and another input end connecting to the power supply line; and
an organic light-emitting diode which has a cathode and an anode, the anode being connected to the power supply line through the output end of the driver unit;
wherein the organic light-emitting diode element is connected to each other through a co-cathode connection line in a co-cathode fashion, the co-cathode connection line being connected to a resistor which has another end grounded.

2. The display device driving apparatus of claim 1, wherein the switch unit is a thin film transistor.

3. The display device driving apparatus of claim 1, wherein the driver unit is a thin film transistor.

4. The display device driving apparatus of claim 1, wherein the storage unit is a capacitor.

5. A method for driving a display device to automatically adjust the optimum brightness under limited power consumption with the display device consisting of a plurality of pixel devices, each pixel device having a driver unit to drive an organic light-emitting diode to emit light, the method comprising steps of:
interconnecting the organic light-emitting diode of each pixel in a co-cathode fashion through a co-cathode connection line;
connecting the co-cathode connection line to a resistor;
grounding other end of the resistor; and
connecting the anode of the organic light-emitting diode of each pixel to a power source line through the driver unit;
wherein total current (Iₜₒₜₐₗ) variations flowing out of the co-cathode connection line is used to generate different voltage drops across the resistor and adjust Vsd (voltage between the source electrode and the drain electrode) of the driver unit thereby to alter the ratio value of each gray scale brightness relative to image data value.
